(19) United States
(12) Patent Application Publication
(10) Pub. No.: US 2026/0356479 A1
(43) Pub. Date: Nov. 12, 2026

(54) TOP ASSEMBLY FOR AN AIRCRAFT CABIN WASTE COLLECTING AND SORTING TROLLEY

(71) Applicant: DRIESSEN CATERING EQUIPMENT BV, Alkmaar (NL)

(72) Inventor: Hans HULSHOFF, Alkmaar (NL)

(21) Appl. No.: 19/134,801

(22) PCT Filed: Dec. 1, 2022
(86) PCT No.: PCT/EP2022/084117

§ 371 Date: Jun. 2, 2025

(51) Int. Cl. B64D 11/00; B65F 1/00; B65F 1/16

(52) U.S. Cl. CPC B64D 11/00; B65F 1/006; B65F 1/1646

(57) ABSTRACT

The present disclosure concerns a top assembly for a waste collecting and sorting trolley of an aircraft cabin, comprising a rectangular support frame defined by two linear lateral sides and two linear end sides joining the lateral sides, the lateral sides being longer than the end sides, and comprising two top flaps for closing a top opening of the assembly bordered by the support frame, each top flap extending along one of the lateral side and being mechanically coupled to it.

### FIELD OF THE INVENTION

This invention relates to a top assembly for a waste collecting and sorting trolley of an aircraft cabin, and to a waste collecting and sorting trolley comprising the top assembly.

### BACKGROUND OF THE INVENTION

Trolleys are generally known in the field of aircraft cabin catering. Flight attendants usually deliver meals comprising food and beverage to the passengers during a flight using a meal trolley, also called galley or service trolley. The vast majority of meal containers are single-use, which results in different types of waste. For example, food may be served on paper plates, and cutlery may be made of wood or hard plastic. For example, beverages may be served in aluminum cans or plastic bottles, and with a soft plastic or cardboard glass for drinking. Another type of waste from on-aircraft meals is leftover or uneaten food and beverages. Other waste may include magazines. Serving meals on an airplane therefore generates different types of waste. Currently, this waste is usually collected by the aircraft crew and burned or sent to landfill. Attendants usually use a dedicated, waste trolley for collecting waste during flight. Such a waste trolley is generally small in size to minimize the space needed to store it in the aircraft and the weight carried on board. For example, it can have a relatively narrow width of about 30 cm to fit in the aisles between the aircraft seats. In this way, a flight attendant can move around while keeping the trolley close by, which facilitates waste collection. The height of the trolley, typically 103 cm, is limited by the height of the storage space in the aircraft into which it is inserted when not in use. The storage space of the trolley is for example a cabinet in which the trolley is inserted.

A waste trolley typically includes a waste intake opening on its top that is configured to access and insert waste into the waste compartment located inside the trolley body. To meet fire hazard standards, the waste inlet opening must be closable. In this way, the waste inlet opening is usually closed when the waste trolley is stored after use and until it is unloaded from the waste it contains, i.e. after the aircraft has landed. Current waste trolleys therefore include a cover for closing the waste intake opening, the cover remaining open throughout the collection of the waste. To reduce the risk of fire, the cover in the open position preferably protrudes from the top of the trolley, so that the trolley cannot be inserted into the trolley storage space in the aircraft.

Burning waste or sending waste to landfill creates costs for the airlines. In addition, increasingly strict standards are being introduced in many countries to require waste separation in order to improve waste recovery, for example through recycling. Such waste separation can be performed by the flight attendants while collecting the waste of passengers. However, current waste trolleys are not suitable for sorting easily and efficiently several types of waste given the above-mentioned size and security restrictions on the trolleys. Therefore, there remains a need in the art for waste collecting and sorting trolleys allowing easier and more efficient sorting of the waste in an aircraft cabin.

### DISCLOSURE OF THE INVENTION

An object of the present invention is to provide technical means to enable an easier and more efficient collecting and sorting of wastes, for instance into two or more categories, by attendants in an aircraft in flight. In particular, these technical means allow for sorting easily and efficiently several types of waste given the above-mentioned size and security restrictions on the trolleys.

For this purpose, the invention provides a top assembly for a waste collecting and sorting trolley of an aircraft cabin, comprising a rectangular support frame comprising two lateral sides mainly extending along a longitudinal axis and two end sides defining a top opening for accessing at least one waste compartment in an interior space of the trolley. The top assembly is characterized in that it comprises two lateral top flaps configured for fully closing the top opening, each mainly extending along the longitudinal axis and being mechanically coupled to one of the lateral sides via a first hinge joint.

The invention provides a top assembly for mounting on a waste collecting and sorting trolley of an aircraft cabin, herein referred to as a trolley. When mounted, the top assembly can form a top of the trolley, preferably an entirety of the top of a trolley. The top of the trolley designates an upper end of the trolley along the vertical direction when the trolley is in use. This upper end or most elevated portion of the trolley is typically opposed along the vertical direction to a lower end of the trolley having supporting wheels coupled thereto and contacting the floor of the aircraft cabin when the trolley is in use.

The top assembly comprises a rectangular support frame comprising two lateral sides mainly extending along a longitudinal axis (Y) and two end sides joining the lateral sides and extending transversally to the lateral sides along a transversal axis (X). The transversal axis is parallel to the end sides and perpendicular to the longitudinal axis (Y). When mounted on the trolley, the top assembly is preferably configured such that the longitudinal axis (Y) is aligned with a direction of displacement of the trolley in use, for example along an aisle of an aircraft cabin. The top assembly is preferably configured for mounting on the trolley by coupling the rectangular support frame to walls and/or to a structure of the trolley, such that the lateral sides mate respective lateral walls of the trolley and the end sides mate respective end walls of the trolley. The top assembly can be configured for mounting on the trolley in a removable way or not.

The two lateral and end sides of the rectangular support frame define a top opening configured for accessing one or preferably several waste compartments in an interior space of the waste sorting trolley. For example, the top opening can be configured for accessing two, or three, or four, or more than four waste compartments in the interior space of the waste sorting trolley.

A surface of the top opening is preferably planar. The top opening can comprise a single main aperture or be divided into several apertures for accessing corresponding waste compartments. For example, the top assembly can comprise a dividing plate closing the top opening and comprising one or more apertures, wherein each aperture is preferably configured for providing access to a corresponding waste compartment. Preferably, the dividing plate can be removably coupled to the top assembly and interchanged with another dividing plate with different dimensions or numbers of apertures to adapt the trolley for collecting other types of waste or a different number of waste types.

The rectangular support frame is preferably not square and preferably having lateral sides that are longer than the end sides. In this way, the top opening surface area can be maximized for providing larger access to the waste compartments, while still ensuring that the top assembly can fit and be displaced without undue burden by a flight assistant in the aisles between the rows of seats in an aircraft.

The top assembly according to the invention is characterized in that it comprises two lateral top flaps, herein referred to as the top flaps, that are configured for fully closing the top opening. Each of the two top flaps is mechanically coupled to one of the lateral sides via a respective first hinge joint. The rotation axis of each hinge joint is preferably parallel to the longitudinal axis (Y). The two top flaps are coupled to different lateral sides. Each of the two lateral top flaps is mainly extending along the longitudinal axis (Y).

The top assembly according to the invention allows to open and close the top opening for accessing or preventing access the waste compartments in the interior space of the trolley, respectively. In the invention, the two lateral top flaps coupled to the lateral sides and mainly extending along the longitudinal axis (Y) can achieve optimal trade-off between closing a top opening with maximized top opening surface area and preventing the top flaps from extending too much outside of the trolley when the top opening is opened. On the one hand, maximizing the top opening surface area allows to collect and sort a wider variety of waste types, because this provides access to a greater number of waste compartments which is important for sorting waste of various types. On the other hand, preventing the top flaps from extending too much outside of the trolley when the top opening is opened for providing access to the waste compartments is important because this reduces the efforts by a flight attendant for avoiding the opened top flaps when collecting and sorting the waste. When seated next to the aircraft aisles, passengers may have their heads in the vicinity of the top assembly mounted on a passing by trolley. Preventing the top flaps from extending too much outside of the trolley thus also reduces the risk of collision between a passenger's head and the top flaps.

The top opening in the top assembly according to the invention can be configured for accessing all or only part of the waste compartments in an interior space of the waste sorting trolley. For example, the trolley can comprise other compartments not accessible via the top opening but via apertures in the end walls of the trolley.

Preferably, each top flap is substantially rectangular. Preferably, each top flap is extending along all of the lateral side. Preferably, each top flap is extending over an entire top opening depth measured along the longitudinal axis (Y) and separating the two end sides. Preferably, the two top flaps are similar. This allows for reducing the number of different parts for manufacturing the top assembly.

In a preferred embodiment of the top assembly according to the invention, the top flaps are double-hinged. This allows for folding the top flaps and prevents the top flaps from excessively protruding out of the trolley when the top opening is open. Preferably, each double-hinged top flap comprises a proximal flap which is mechanically coupled to a respective lateral side via the first hinge joint, and a distal flap which is mechanically coupled to the proximal flap via a second hinge joint. Preferably, the rotation axes of the first and second hinge joints are parallel to the longitudinal axis (Y). This reduces an extension of the top flaps out of the trolley when the top opening is opened while making it very compact and practical.

In an example, the proximal and distal flaps can be substantially rectangular and mainly extending along the longitudinal axis (Y). This further reduces the extension of the top flaps out of the trolley when the top opening is opened. Each of the proximal and distal flaps preferably extends over an entire top opening depth measured along the longitudinal axis (Y) from one end side to the other end side, to further reduce the extension of the top flaps out of the trolley when the top opening is opened.

Preferably, each top flap is reversibly movable between:
an unfolded position corresponding to a closed configuration of the top opening wherein both the proximal and distal flaps extend along a plane parallel to the support frame, and
a folded position corresponding to an opened configuration of the top opening, wherein the distal flap is folded towards the proximal flap.

In the unfolded position, the proximal and distal flaps preferably extend mostly parallel to the top opening surface and each close a portion of the top opening.

When the two top flaps are in the unfolded position, the top opening is entirely closed by the top flaps and access to the waste compartments is prevented. In the unfolded position of the top flaps, the proximal and distal flaps of the two top flaps preferably extend mostly parallel to the lateral and longitudinal axes. When the two top flaps are in the folded position, the top opening is opened to provide access to the waste compartments. In the folded position of the top flaps, each of the proximal flaps preferably extend mostly parallel to a corresponding proximal flap plane and an angle between a normal to the corresponding proximal flap plane and the transversal axis is preferably comprised between −20° and 20°, preferably between −10° and 10°. In the folded position of the top flaps, each of the distal flaps preferably extends along a corresponding distal flap plane such that an angle between a normal to the corresponding distal flap plane and the transversal axis is preferably comprised between −20° and 20°, preferably between −10° and 10°.

Preferably, the folded and unfolded positions are extremal positions of the top flaps, and the top flaps can move continuously therebetween. When a trolley with the top assembly according to the invention mounted thereon is in use, the top assembly is preferably configured such that the top flaps are stable when placed in the folded and unfolded positions such that the top opening remains open or closed without having to continuously maintain the folded or unfolded position of the top flaps by a user.

Preferably, each top flap comprises a handle configured for allowing a user to hold and move the top flap. In an example, the handle is coupled to the distal flap of the top flap. Preferably, the handle is a central handle coupled to the distal flap such that it is equidistant from the end sides. In this way, it can be easily reached by users standing next to the end sides of a trolley with the top assembly mounted thereon. In the unfolded configuration of the top flap, the handle can be configured for projecting out from the distal flap coupled thereto and upwardly along a vertical axis (Z), wherein the vertical axis (Z) is perpendicular to the transversal (X) and longitudinal (Y) axes.

In an example, the top assembly is configured such that the proximal or distal flap is slanted towards the top opening when the top flap is in the folded position, and preferably act as a waste chute towards the top opening. Preferably, the top assembly is configured such that the distal flap is slanted towards the top opening when the top flap is in the folded position. In this configuration, the distal flap can act as a waste chute towards the top opening. In other words, waste contacting the distal flap can slide along the distal flap and fall in a waste compartment via the top opening under the effect of gravity, for example. It is for instance the case, in the context of the above-mentioned embodiment having an angle between said normal to each distal flap plane and the transversal axis is comprised between 5° and 20° in absolute value, e.g. of about 10° or 15° in absolute value.

Preferably, the top assembly has an external top assembly width measured along the transversal axis (X) and is configured such that each of the two top flaps is not protruding outside of the external top assembly width when the top flaps are in the folded position. This means that, along the transversal axis (X), each top flap in the folded position is comprised within the external top assembly width i.e., extends along the transversal axis (X) within the boundaries defined by the external top assembly width. Having each top flap in the folded position not extending out of the top assembly width along the transversal axis (X) reduces the risk of collision between the top flaps and a head of a passenger during the collecting and sorting of the waste.

The top assembly with the top flaps unfolded and closing the top opening has an external top assembly height measured along the vertical axis (Z). Preferably, the top assembly is configured such that each of the two top flaps in the folded position such that the top opening is open extends out of the top assembly height along the vertical axis (Z). In this way, the folded top flaps project vertically upwards from the top assembly mounted on a trolley in use. The top flaps projecting upwardly from the top assembly mounted on a trolley in use prevents a user from inserting the trolley in its storage place in the aircraft cabin when one of the two top flaps is folded. This prevents fire hazards as the top opening should be closed when the trolley is in its storage place.

In a preferred embodiment of the top assembly comprising the proximal and distal flaps, each top flap comprises a runner surface extending along the longitudinal axis (Y) and arranged for mating, and preferably holding, an accessory above the top opening. Preferably, the runner surface extends along the longitudinal axis (Y) over substantially an entire length of the lateral sides measured along the longitudinal axis (Y), or each top flap comprises a plurality of coplanar runner surfaces distributed over substantially the entire length of the lateral sides. Preferably, the accessory is a drawer, for example a drawer which can be used as an additional waste sorting compartment. Preferably, the runner surface of each top flap is configured for mating the accessory when the top flap is folded. The runner surfaces of the two folded top flaps are preferably configured for supporting the accessory against gravity, and preferably allow for sliding the accessory along a direction parallel to the longitudinal axis (Y). The top assembly is preferably configured such that, when mounted on a trolley in use, a normal to the runner surface of each folded top flap is oriented vertically upward. In an example, each top flap also comprises a lateral rim, preferably forming an angle iron with the runner surface, and configured for mating the accessory and preventing a displacement of the accessory along a direction parallel to the transversal axis (X) when the top flap is folded. This allows for sliding the accessory above the top opening and along a direction parallel to the longitudinal axis (Y), while preventing the accessory from translating in a direction parallel to the transversal axis (X) and falling down from the top assembly. For example, the angle iron can be configured for receiving a basis or feet of a drawer. Each top flap can also comprise on or more longitudinal stopper for limiting an amplitude of a sliding range of the accessory along the longitudinal axis. Preferably, the one or more longitudinal stoppers are configured for preventing the accessory from displacing along the longitudinal axis beyond ends of the runner surfaces. In this way, the accessory is prevented from projecting out of a top assembly external depth of the top assembly which is measured along the longitudinal axis.

Preferably, the runner surface of each top flap is formed at a level of, or substantially at a level of, the second hinge joint when the top flap is in the folded position. In this way, the drawer can be supported in an elevated position with respect to the top opening of the top assembly mounted on the trolley in use, preferably such that user access to the waste compartments are unobstructed and as wide as possible. In an example, the top assembly is configured such that a distance measured along the vertical axis and separating the accessory from the top opening is comprised between 4 and 15 cm, preferably comprised between 5 and 10 cm, preferably about 7 cm.

The embodiment of the top assembly with each top flap comprising a runner surface can be configured for using in combination with one or more interchangeable accessories, and for achieving the effect described above of supporting against the gravity, and guiding and sliding various accessories along the longitudinal axis (Y).

The top assembly preferably comprises a flaps blocker, herein also referred to as a flaps catcher, configured for blocking at least one of, and preferably both of, the top flaps in at least one of the unfolded and folded positions.

Preferably, the flaps blocker is configured for holding the top flaps in the folded position and keeping the top opening opened for accessing the waste compartments in an interior space of the trolley, such that when the top assembly is mounted on a trolley in use, the top flap in the folded position is stable under the effect of gravity.

Preferably, the flap blocker for blocking one of the top flaps in the folded position comprises a projection from each of the end sides endowed with a recess dimensioned for receiving a distal edge of a corresponding distal flap, the distal edge being opposite to the second hinge joint.

Preferably, the top assembly comprises two flap catchers each configured for blocking a different one of the two top flaps in the folded position, wherein each of the two flap catchers comprises a projection from each of the end sides endowed with a recess dimensioned for receiving a distal edge of a corresponding distal flap, wherein the distal edge of a distal flap is located opposite to the second hinge joint of the same distal flap. In this embodiment, a top flap can preferably be positioned in the folded configuration with its distal edge received in the recesses of each end side, such that the projections prevent the distal edge from displacing along a direction exclusively parallel to the transversal axis (X), and such that flap catcher prevents the top flap from displacing towards the unfolded position under the effect of gravity alone.

The invention also concerns a waste collecting and sorting trolley, herein also referred to as the trolley, comprising the top assembly according to the invention.

The embodiments and the advantages of the top assembly according to the invention extend mutatis mutandis to the trolley according to the invention.

The “use position” or “position of use” of the trolley corresponds to a normal use of the trolley in an aircraft cabin i.e., when the trolley is displaced on a substantially horizontal floor parallel to the transversal and longitudinal axes to serve the aircraft passengers. The top assembly mounted on the trolley in the use position is located in a most elevated part of the trolley along the vertical axis (Z), and preferably constitutes the most elevated part of the trolley along the vertical axis. A body of the trolley encloses the interior space of the trolley and extends over an external trolley body width and an external trolley body depth measured along the transversal axis (X) and the longitudinal axis (Y), respectively. Preferably, the top assembly mounted on the trolley extends along the transversal axis (X) and the longitudinal axis (Y) over an entirety of the external trolley body width and depth, respectively. In this way, the top opening surface area is maximized without the top assembly projecting out of the external trolley body width and depth along the transversal and longitudinal axes, respectively.

The trolley is preferably a trolley having standard dimensions for using in cabins of current commercial passenger planes. Preferably, the trolley body is substantially in a shape of a box or rectangular cuboid.

Preferably, the trolley of the invention has an external trolley width measured along the transversal axis (X) of about 30 cm, the external trolley width being preferably equal or substantially equal to the external trolley body width.

Preferably, the trolley of the invention has an external trolley depth measured along the longitudinal axis (Y), the external trolley depth being preferably equal or substantially equal to the external trolley body depth. For example, the external trolley depth can be of about 81 cm and the interior space of the trolley preferably comprises 4 waste compartments, or the external trolley depth can be of about 40 cm and the interior space of the trolley preferably comprises 2 waste compartments.

Preferably, the trolley of the invention has an external trolley height measured along the vertical axis (Z) of about 103 cm.

Preferably, a top opening width of the top opening surface is measured along the transversal axis (X) and is comprised between 15 and 28 cm, preferably between 20 and 25 cm, preferably between 22 and 25 cm.

Preferably, the trolley is chosen among:
a trolley with the external trolley depth of about 81 cm, and the top opening depth comprised between 65 and 70 cm;
a trolley with the external trolley depth of about 40 cm, and the top opening depth is comprised between 30 and 35 cm.

The invention also concerns the use of a waste collecting and sorting trolley according to the invention for collecting and sorting waste in an aircraft cabin.

The embodiments and the advantages of the top assembly according to the invention extend mutatis mutandis to said use.

The trolley can be used to collect waste in an aircraft cabin by displacing the trolley in the cabin and keeping it close to the flight attendant collecting the waste such that waste collecting time is reduced. This can be achieved by choosing standardized dimensions for the trolley such that it can be displaced in the aisles and stored in standard passengers airplanes. After taking the waste of a passenger, a flight attendant can sort it by throwing the different elements of the waste via the top opening in separate waste compartments according to their type. The types of waste can comprise cardboard, aluminum cans, food leftovers, plastic cutlery, etc.

The invention also concerns a method for opening the waste collecting and sorting trolley according to the invention, the top opening of which is fully closed by the top flaps. The method comprises a step of pushing each top flaps towards the lateral side to which it is mechanically coupled. This allows to open easily the top opening while providing all the above-mentioned advantages of the top assembly according to the invention.

More generally, the embodiments and the advantages of the top assembly according to the invention extend mutatis mutandis to the method according to the invention.

The disclosed subject matter is further introduced in the claims. As it will be understood by a skilled person from this disclosure, any one of the embodiments presented in these claims can be considered alone or in combination. In particular, the dependency of the claims can be considered in a broader manner so that any one of the possible combinations of the claims—as far as they are technically possible and understood by the person skilled in the art, in particular in view of the present disclosure—are part of the present application.

### BRIEF DESCRIPTION OF THE DRAWINGS

Other features and advantages of the invention will appear on reading the detailed description that follows, for the understanding of which, it is referred to the attached drawings.

The list of these drawings is the following:

FIG. 1a illustrates a view in perspective of an embodiment of the top assembly according to the invention, wherein the top flaps are in the unfolded position i.e., the top opening is closed;

FIG. 1b illustrates a view in perspective of the embodiment of the top assembly of FIG. 1a, wherein the top flaps are in the folded position i.e., the top opening is opened;

FIG. 2 illustrates a cross-sectional view of the embodiment of the top assembly of FIG. 1b;

FIG. 3 illustrates a perspective view of a body of a waste collecting and sorting trolley according to the invention with the top assembly mounted thereon;

FIG. 4a illustrates a view from above of a top assembly according to the prior art with opened top openings;

FIG. 4b illustrates a view from above of a top assembly according to the invention with the top opening opened;

FIG. 5a illustrates a perspective view of the top assembly of FIG. 1a with the two folded top flaps supporting a drawer;

FIG. 5b illustrates a cross-sectional view of the top assembly with a drawer of FIG. 5a.

The drawings may be not scaled. Similar elements are assigned by similar references. In the framework of this document, identical or analogous elements may have the same references. The presence of reference in the drawings cannot be considered to be limiting, comprising when these references are indicated in the claims.

### DETAILED DESCRIPTION OF SPECIFIC EMBODIMENTS OF THE INVENTION

This part of the document presents a description of specific and preferred embodiments of the invention with references to the drawings. The invention is however not limited by these references. The Figures that were introduced above are in particular only schematic and not limiting in any way.

Some of the Figures are provided with abstract geometric marks mainly used to quantify and visualize technical characteristics of embodiments of the invention such as measures or geometric characteristics. These geometric marks generally do not correspond themselves to concrete material objects. They comprises a 3D spatial references forming an orthogonal basis of the usual Euclidian 3D ambient space defines by the three following axes: a transversal axis X, a longitudinal axis Y, and a vertical axis Z.

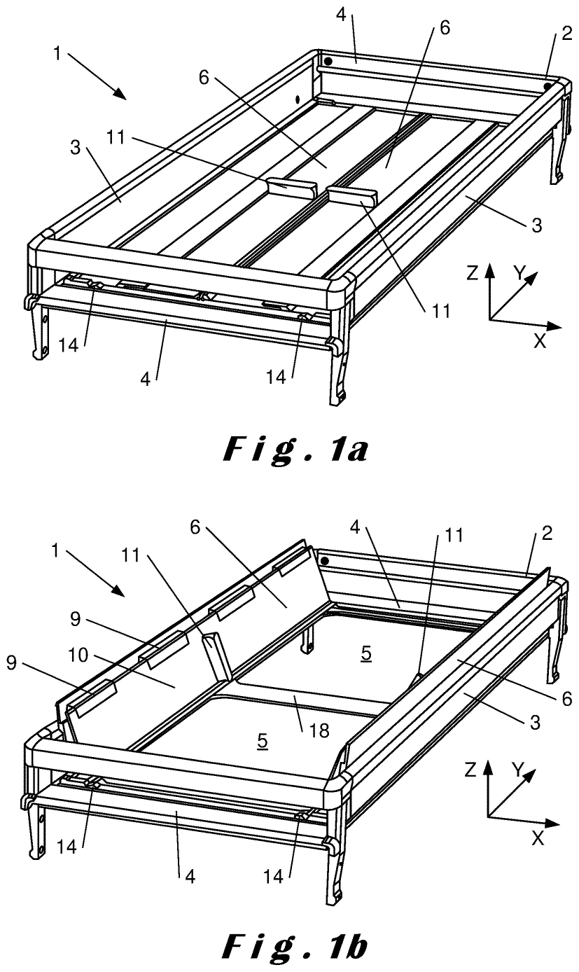

FIG. 1a illustrates a top assembly 1 for a waste collecting and sorting trolley in an aircraft cabin. The top assembly 1 comprises two lateral sides 3 comprising elongated profiles extending mostly parallel to the longitudinal axis Y, and two end sides 4 comprising elongated profiles extending mostly parallel to the transversal axis X. The end sides join the extremities of the lateral sides to form a support frame 2 which is rectangular. The end and lateral sides define a top opening 5 as shown in FIG. 1b. The top opening 5 is enclosed by the end and lateral sides and has a top opening surface which is planar and normal to the vertical axis Z.

As shown in FIG. 3, the top opening is configured for providing access to an interior space of the trolley 100 having the top assembly mounted thereon. In the example of trolley illustrated in FIG. 3, the interior space of the trolley is enclosed in a body of the trolley 100 which is shaped like a box and contains four waste compartments 101 each opening substantially at a level of the top opening 5.

The top assembly according to the invention comprises top flaps 6 for closing the top opening and preventing access to the waste compartments. When the trolley with the top assembly mounted thereon is not in use and stored in a cabinet, the top flaps 6 separate the waste compartments from an exterior environment of the trolley to reduce fire hazard or propagation. Thus, the top flaps are configured for closing an entirety of the top opening. In other words, the top flaps cover all the top opening as shown in FIG. 1a. To allow for collecting and sorting the waste in the aircraft cabin, the top flaps can be moved to open the top opening and free the access to the interior space of the trolley wherein waste compartments 101 are installed.

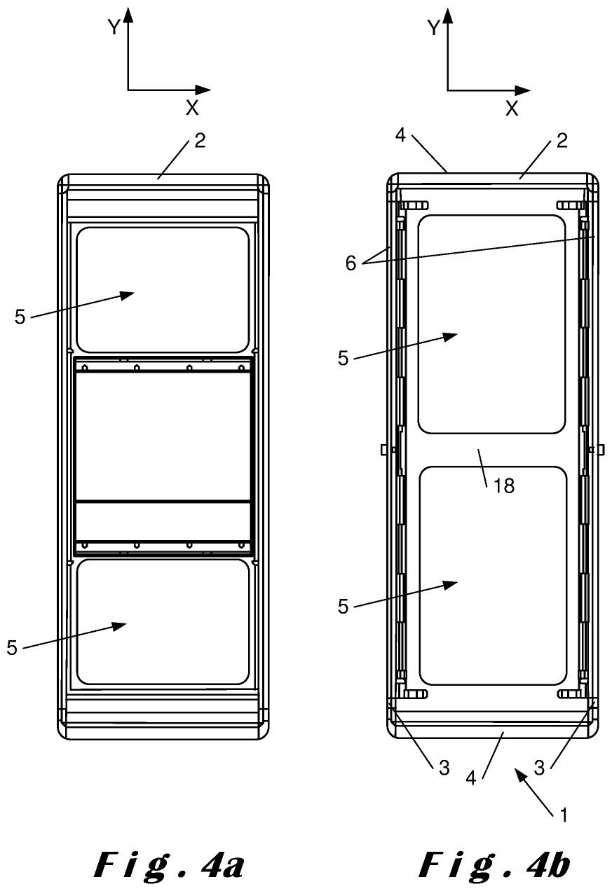

There is a trend of increasing the sorting of waste in many countries. However, existing trolleys and in particular existing trolley top assemblies are not suitable for the sorting of many types of waste. In FIG. 4a, a top assembly of the prior art is illustrated from above, wherein two top openings 5 are opened by rotating the flaps 5 in an open position. The flaps are configured to close the top openings. To open the top openings, the flaps of the prior art can be rotated of about 180° around hinges with axes parallel to the transversal axis X, and positioned in a central portion of the top assembly located between the two top openings as shown in FIG. 4a. Each flap must be wide enough to entirely close the corresponding top opening, and small enough to avoid obstructing the other top opening when opening its corresponding top opening. This tradeoff is an intrinsic limitation of existing trolley top assemblies which limits the top openings total surface area and thus the number of waste compartments for sorting waste accessible via the top opening.

As illustrated in FIG. 4b, the top assembly according to the invention overcomes the limitation of the prior art and provides a wider top opening surface area. The top opening surface area is maximized while avoiding the top flaps from projecting to much out of the trolley, thus avoiding accidental closure when manipulating waste and hurting of passengers when moving the trolley close to them. As illustrated in FIGS. 1a and 1b, the top assembly according to the invention comprises two top flaps 6 which are lateral top flaps. Each of the two top flaps 6 is mechanically coupled to a respective lateral side 3 via a first hinge joint, the two top flaps 6 being coupled to different lateral sides 3. Each of the two top flaps extends mainly along the longitudinal axis Y. The invention is not limited to the number of two top flaps, although this number is preferred because it allows a symmetric configuration of the top assembly while limiting the space requirements of the top flap beyond the trolley dimensions.

The top assembly according to the invention advantageously provides flexibility in the number of waste compartments of the trolley which can be reached by a user, for example by using interchangeable waste compartments inside the trolley. Preferably, the number of waste compartments accessible via the top assembly according to the invention can be varied. For example, a trolley comprising four waste compartments as illustrated in FIG. 3 can be modified to comprise five or three waste compartments to adapt to local waste sorting regulations.

The invention should not be restricted to a top assembly mounted on a trolley comprising a specific number of waste compartments, in particular a plurality of waste compartments. The goal of the top assembly according to the invention is to allow for collecting and sorting waste according to a plurality of waste types. For example, a same top assembly according to the invention can be configured to access:
a single waste compartment of the trolley, while other waste compartments are preferably accessed from apertures in the side panels of the trolley, or
a plurality of waste compartments of the same trolley, after the number of compartments of the same trolley has been modified.

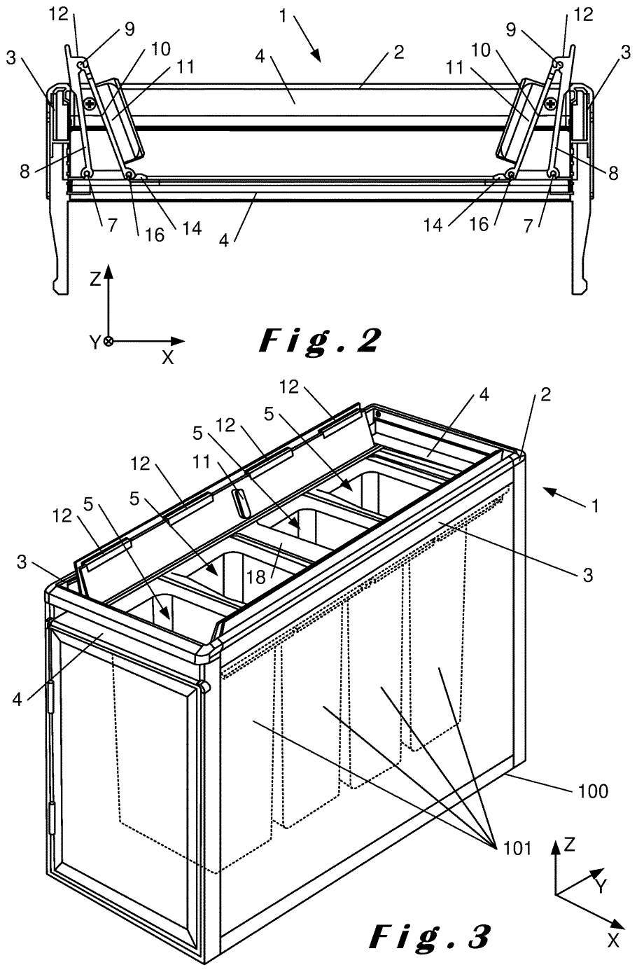

In a preferred embodiment illustrated in FIGS. 1a, 1b and 2, the two top flaps are similar. Each of the two top flaps is double-hinged and comprises a proximal flap 8 which is mechanically coupled to a respective lateral side 3 via the first hinge joint 7, and a distal flap 10 which is mechanically coupled to the proximal flap 8 via a second hinge joint 9. The axes of the first and second hinge joints are parallel to the longitudinal axis Y. In this way, a user standing in front of one of the end sides 4 of the top assembly mounted on a trolley in use can open the top opening by spreading the top flaps laterally towards the lateral sides. Preferably, each distal flap 10 comprises a handle 11 for holding the corresponding top flap. The handles 11 illustrated in FIG. 1a, 1b, 2, 3 are central handles projecting out of an upper surface of the distal flaps which is oriented towards an exterior of the trolley when the top flaps are in the folded position and the top opening is closed. The central handles are located substantially halfway between the two end sides 4 of the top assembly 1. Preferably, the handles are configured for projecting vertically upwards along the vertical axis Z when the top flaps are in the folded position shown in FIG. 1a, such that a user can grip each of them with the fingers of a hand, and push the two flaps towards the lateral sides.

Preferably, the proximal and distal flaps are substantially rectangular plates extending mostly parallel to the transversal axis X and longitudinal axis Y when the top flaps are in the unfolded configuration and closing the top opening as illustrated in FIG. 1a. The proximal and distal flaps extend over a top opening depth from one end side to the other end side, and are elongated along the longitudinal axis Y.

In the folded configuration illustrated in FIGS. 1b, 2 and 3, the proximal flap 8 of each top flap is rotated around the first hinge and leans against the lateral side attached thereto when the top flap is in the folded configuration. In this way, the lateral side 3 limits the rotating range of the proximal flap around the axis of the first hinge. The distal flap 10 is folded towards the proximal flap and slanted towards the top opening 5. In this way, the distal flap can act as a chute and guide waste parts towards the top opening and the interior space of the trolley.

In the folded configuration shown in FIG. 1b, the top flaps are projecting out of the top assembly along the vertical axis i.e., the most elevated part of the top assembly mounted on a trolley in use belongs to the top flaps as shown. In the unfolded configuration shown in FIG. 1a, the top flaps are not projecting out of the top assembly along the vertical axis as shown in FIG. 1. In this way, a total height measured along the vertical direction of a trolley with the top assembly mounted thereon is strictly greater if the top flaps are in the folded configuration and the top opening is unobstructed than if the top flaps are in the unfolded configuration and the top opening is closed. This prevents accidental storage of the trolley with its top opening left open, for example in a case wherein the storage place of the trolley is configured for closely fitting a height of the trolley with the top flaps unfolded.

As shown in FIGS. 1a and 1b, the top flaps are configured for remaining out of the interior space of the trolley when moving between the folded and unfolded position. In other words, the top flaps are configured for folding above the top opening such that they do not penetrate into the interior space of the trolley. In this way, the waste compartments can extend up to a vicinity of to the top opening to maximize a volume of the waste compartments.

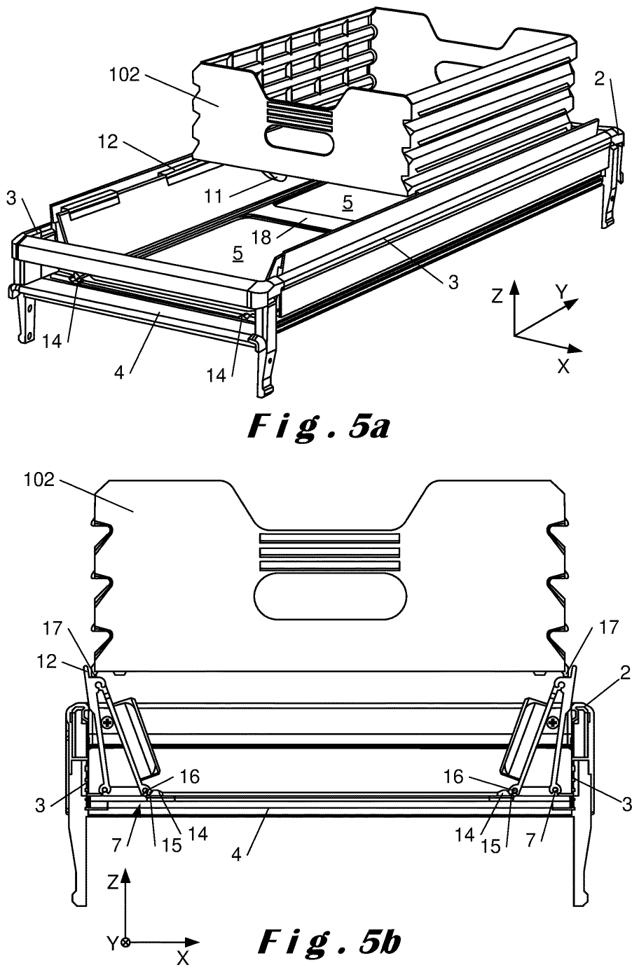

The top assembly of FIGS. 1a and 1b is configured such that, when mounted on a trolley in the use position, the top flaps are stable in the folded and unfolded positions. For example in FIG. 1a, the top flaps 6 in the unfolded position are supported by the end sides 4 and rest on the end sides under the effect of gravity, such that they do not move towards the interior space of the trolley under the effect of gravity. For example in FIGS. 1b and 2, the top flaps 6 in the folded position are also stable. Firstly, the top assembly is configured such that each proximal flap 8 in the unfolded position rests against the corresponding lateral side 3. This also provides the effect that the rotation of the proximal flap 8 of each top flap around the axis of the first hinge 7 is limited by the corresponding lateral side such that the proximal flap does not project out of the external top assembly width, the external top assembly width being measured along the transversal axis X. Secondly, the top assembly comprises flap blockers, herein also referred to as flap catchers. As shown in FIG. 5b, each flap blocker comprises a projection 14 from at least one end side 4, preferably projections 14 from each end side 4, wherein each projection 14 is endowed with a recess 15 configured for receiving a distal edge 16 of a corresponding distal flap. The projection 14 adjacent to the recess 15 is configured for preventing a sliding of the distal edge 16 along the transversal axis X. In this way, the flap blocker prevents the top flap in the folded position from returning towards the unfolded position under the effect of gravity alone.

Preferably, the top assembly is configured such that a smaller angle between a plane comprising the top opening surface and the proximal flap is comprised between 80° and 90° when the top flap is in the folded position. Preferably, the top assembly is configured such that a smaller angle between the plane comprising the top opening surface and the distal flap is comprised between 70° and 90° when the top flap is in the folded position.

As shown in FIG. 1b, the top assembly can comprise a dividing plate 18 configured for dividing the top opening surface into a plurality of apertures of smaller areas and configured for accessing corresponding waste compartments. In FIG. 1b and FIG. 4b, the dividing plate 18 separates the top opening 5 into two apertures of equal areas.

As illustrated in FIGS. 5a and 5b, the top assembly can also comprise a runner surface configured for supporting an accessory, for example a drawer 102. In the example of FIG. 5a, the runner surface belongs to the proximal flap and is adjacent to the second hinge. It is configured for receiving and supporting feet 17 of the drawer positioned above the top opening. The runner surfaces are normal to the vertical axis Z when the top flaps are in the folded position. They extend mostly along the longitudinal axis Y. The runner surfaces are configured for allowing the drawer to slide parallel to the longitudinal axis Y, such that a user can choose which portions of the top opening are obstructed or unobstructed by the drawer by displacing it along the runner surface. Preferably, each top flap further comprises a lateral rim which forms an angle iron 12 in combination with the runner surface when the top flaps are in the folded position. As shown in FIG. 5b, each lateral rim is configured for limiting a displacement of the accessory mated therewith along the transversal axis X. In FIG. 5b, the angle irons 12 of the two top flaps are configured for guiding the drawer in translation along the longitudinal axis Y and for preventing a translation of the drawer along the transversal axis X.

The invention also concerns a trolley 100 for collecting and sorting waste in the cabin of an aircraft, and comprising the top assembly according to the invention. Such trolley can comprises a number of waste compartments, at least one of which is accessible via the top opening 5. The trolley can have an external trolley width of about 30 cm measured along the transversal axis X. The trolley can have an external trolley height of about 103 cm measured along the vertical axis Z. In an example, the external trolley depth is preferably of about 81 cm, the top opening depth is comprised between 65 and 70 cm and the interior space of the trolley comprises four waste compartments accessible via the top opening. In another example, the external trolley depth is preferably of about 40 cm, the top opening depth is comprised between 30 and 35 cm, and the interior space of the trolley comprises two waste compartments accessible via the top opening. The top opening width is preferably comprised between 20 and 25 cm.

In other words, the invention concerns a top assembly for a waste collecting and sorting trolley of an aircraft cabin, comprising a rectangular support frame defined by two linear lateral sides and two linear end sides joining the lateral sides, the lateral sides being longer than the end sides, and comprising two top flaps for closing a top opening of the assembly bordered by the support frame, each top flap extending along one of the lateral sides and being mechanically coupled to it.

The invention was described in relation to the specific embodiments which have a value that is purely illustrative and should not be considered to be limiting. In particular, all the values mentioned in this description are provided with an error margin of 5%. Generally speaking, it will seem obvious for the person skilled in the art that the invention is not limited to the examples or measured values illustrated or described above, and that the invention scope is more broadly defined by the claims introduced below.

References

| | |
|---|---|
| 1 | Top assembly |
| 2 | Support frame |
| 3 | Lateral side |
| 4 | End side |
| 5 | Top opening |
| 6 | Top flaps |
| 7 | First hinge joint |
| 8 | Proximal flap |
| 9 | Second hinge joint |
| 10 | Distal flap |
| 11 | Handle |
| 12 | Angle iron |
| 14 | Projection |
| 15 | Recess |
| 16 | Distal edge |
| 17 | Feet of the drawer |
| 18 | Dividing plate |
| 100 | Trolley |
| 101 | Waste compartments |
| 102 | Drawer |

1. A top assembly for a waste collecting and sorting trolley of an aircraft cabin, comprising a rectangular support frame comprising two lateral sides mainly extending along a longitudinal axis (Y) and two end sides defining a top opening for accessing at least one waste compartment (101) in an interior space of the trolley,
wherein:
the top assembly comprises two lateral top flaps configured for fully closing the top opening, each mainly extending along the longitudinal axis (Y) and being mechanically coupled to one of the lateral sides via a first hinge joint.

2. The top assembly according to claim 1, wherein the two top flaps are similar.

3. The top assembly according to claim 1, wherein the top flaps are double-hinged.

4. The top assembly according to claim 3, wherein each top flap comprises:
a proximal flap mechanically coupled to a respective lateral side via the first hinge joint, and
a distal flap mechanically coupled to the proximal flap via a second hinge joint;
wherein rotation axes of the first and second hinge joints are parallel to the longitudinal axis Y.

5. The top assembly according to claim 4, wherein the distal flap comprises a central handle.

6. The top assembly according to claim 4, wherein the proximal and distal flaps are substantially rectangular and mainly extending along the longitudinal axis (Y).

7. The top assembly according to claim 6, wherein each of the proximal and distal flaps extends over an entire top opening depth measured along the longitudinal axis (Y) from one end side to the other end side.

8. The top assembly according to claim 4, wherein each top flap is reversibly movable between:
an unfolded position corresponding to a close configuration of the top opening, and according to which both the proximal and distal flaps extend along a plane parallel to the support frame;
a folded position corresponding to an open configuration of the top opening, and according to which the distal flap is folded toward the proximal flap.

9. The top assembly according to claim 8, wherein the distal flap is slanted toward the top opening when the top flap is in the folded position.

10. The top assembly according to claim 8, having an external top assembly width measured along a transversal axis (X) parallel to the end sides and perpendicular to the longitudinal axis (Y), wherein the top flap is not protruding outside of the external top assembly width when the top flap is in the folded position.

11. The top assembly according to claim 4, wherein each top flap comprises a runner surface extending along the longitudinal axis (Y) and arranged for mating a drawer above the top opening.

12. The top assembly according to claim 11, wherein each top flap is reversibly movable between:
an unfolded position corresponding to a close configuration of the top opening, and according to which both the proximal and distal flaps extend along a plane parallel to the support frame;
a folded position corresponding to an open configuration of the top opening, and according to which the distal flap is folded toward the proximal flap; and
wherein the runner surface is formed at a level of the second hinge joint when the top flap is in the folded position.

13. The top assembly according to claim 8, comprising a flaps blocker for blocking the top flaps in at least one of the unfolded and folded positions.

14. The top assembly according to claim 13, wherein the flaps blocker for blocking one of the top flaps in the folded position comprises a projection from each of the end sides endowed with a recess dimensioned for receiving a distal edge of a corresponding distal flap, the distal edge being opposite to the second hinge joint.

15. A waste collecting and sorting trolley comprising the top assembly according to claim 1.

16. The waste collecting and sorting trolley according to claim 15, wherein the waste collecting and sorting trolley has:
an external trolley width of about 30 cm measured along a transversal axis (X) parallel to the end sides and perpendicular to the longitudinal axis (Y);
an external trolley depth measured along the longitudinal axis (Y);
an external trolley height of about 103 cm measured along a vertical axis (Z) perpendicular to the transversal (X) and longitudinal (Y) axes;
a top opening width measured along the transversal axis (X) comprised between 20 and 25 cm;
a top opening depth measured along the longitudinal axis (Y); and
wherein the waste collecting and sorting trolley is chosen among:
a waste collecting and sorting trolley with the external trolley depth being of about 81 cm and the top opening depth being comprised between 65 and 70 cm; and
a waste collecting and sorting trolley with the external trolley depth being of about 40 cm and the top opening depth being comprised between 30 and 35 cm.

17. A use of a waste collecting and sorting trolley according to claim 15 for collecting and sorting waste in an aircraft cabin.

18. A method for opening a waste collecting and sorting trolley according to claim 15, the top opening of which is fully closed by the top flaps, comprising a step of pushing each top flaps toward the lateral side to which it is mechanically coupled.
